(19) United States
(12) Patent Application Publication
(10) Pub. No.: US 2004/0034782 A1
(43) Pub. Date: Feb. 19, 2004

(54) Card equipped with secret number input keys and the method of activating the same

(76) Inventor: Jung Woong Park, Seoul (KR)

Correspondence Address: Eugene Oak, Ph. D., J.D., Patent Attorney, 610 S. Van Ness Ave., Los Angeles, CA, 90005, US

(21) Appl. No.: 10/636,890

(22) Filed: Aug. 8, 2003

(30) Foreign Application Priority Data
Aug. 11, 2002 (KR) 10-2002-0069130

(51) Int. Cl. G06F 12/14

(52) U.S. Cl. 713/185; 713/193

(57) ABSTRACT

A device to input a user-defined secret code to activate the card with magnetic film strip, integrated circuitry or the combination of the two and a method of activating the card. The key entry device is fixed at a side of the card. The card equipped with secret code input keys have magnetic film strip, a part or the whole of which are printed without being magnetized and the method of the present invention operates only when the defined secret code is entered and, therefore, can prevent unauthorized use of stolen or lost card. Also the present invention will prevent the use of copied or forged cards.

### FIELD OF THE INVENTION

The present invention relates to a card equipped with input keys to enter and change individualized security codes and the method of activating the same. Such a card can be used as credit cards and automatic teller machine cards. This invention can be applied to a credit card or ATM card with magnetic strips or IC chips or the combination thereof. The application of the present invention to credit/ATM cards will prevent unauthorized use of stolen, lost or copied cards.

### BACKGROUND OF THE RELATED ART

Generally, methods (or device) to add security to credit or cash cards that need various security measures require signatures on the cards or placing a picture ID on the cards. Signatures on the cards, however, cannot prevent unauthorized use of the cards when the unauthorized users forge the signatures at the back side of the card when the cards are stolen or lost, because vendors accepting the cards do not check the signatures closely in many cases. Picture ID's on the cards have the same problem: accepting vendors are not careful all the time to check the face against the picture and also pictures can be replaced when the cards are lost or stolen. Therefore, picture ID's cannot prevent unauthorized use of stolen or lost cards. In order to solve the problems of the conventional methods of card security, there was a device and method using pressure-sensitive buttons on the surface of the cards to enter a secret code. The device and method described in the previous sentence was granted Korean patent No. 2002-45187 under the title of “Card Security Device and Method.”

A card equipped with the Card Security Device and Method described in the previous paragraph is shown in FIG. 1. Such a card has a magnetic film strip (2) that stores card information including the serial number and the secrete number. Such a card consists of the button section operating by pressure (3) on the surface that generates information output to the magnetic film strip (2), the information control section (4) that controls the status of information outflow from printed information on the magnetic film (2), the mode setting section (5) that enables output of information printed on the magnetic film (2) by performing closing and opening function of the information control section (2), and the connection section (6) at a side of the card that provides electric power to the information section (1).

However, the card equipped with the device and method described in the immediately preceding paragraphs has the problems of being susceptible to damages to connecting switches and erratic operations because the button section (3) that has about 10 buttons on the surface is subject to unintended pressure from both sides when the card is stored in the bill folders or in the pockets and the buttons themselves are continually pressed. Also such a card was liable to damages and erratic operation because the button section (3) was pressed when the card was inserted to card readers or ATM machines. Another problem was that it was impossible to place the button section (3) on the limited surface of the typical credit or cash cards. Even if the button section (3) can be placed on the card surface, the size of each button is too small to allow accurate input.

Under the card security scheme described in the immediately preceding paragraphs, a card subscriber had to suffer the inconvenience and burden of having to remember two secret numbers that control the information output from the magnetic film strip (2) all the time, the first being the secret number for the use of the card to be printed on the magnetic film strip (2) and the second the secret number composed of an established combination of the buttons on the button section (3).

Furthermore, with respect to the card using the prior technology, there is a description in the patent that the mode setting section (5) will enable information outflow from the magnetic film (2) by way of closing or opening functions, but the patent description fails to explain how and with what technological means or methods of closing so as not to read the information already printed on the magnetic film strip (2). That is a problem in the technological composition of the device and method.

### SUMMARY OF THE INVENTION

The present invention is directed to a device to input a user-defined secret code to activate the card with magnetic film strip, integrated circuitry or the combination of the two and a method of activating the card. The key entry device is fixed at a side of the card. The card equipped with the device and the method of the present invention operates only when the defined secret code is entered and, therefore, can prevent unauthorized use of stolen or lost card. Also the present invention will prevent the use of copied or forged cards.

To achieve the security purposes stated in the preceding paragraphs, the cards equipped with secret code input keys have magnetic film strip, a part or the whole of which are printed without being magnetized. Such non-magnetized film strip or portion of the film strip is activated only when correct secret code is entered, using the input keys into permanent magnetic sources embedded in the card.

The card equipped with the secret code input keys described in the preceding paragraphs consists of the secret code input keys as described above, the magnetic film strip printed on the card with data signal patterns, a part of whole of which is non-magnetized, the gateway control to control the flow of magnetism to the above-described magnetic film strip, a thin-film permanent magnet to supply magnetism to the above-described magnetic film, and a switch circuitry to supply magnetism to the above-described in accordance with the control of the above-described gateway control.

It is desirable to place two plastic sheets between the front and back sides of the card for the above-described secret code entry keys. The plastic sheet inserted between the front and back sides of the card will have silicon or synthetic rubber on one side. The two plastic sheets can be integrated into one to facilitate the manufacturing process.

It is desirable that the first plastic sheet with silicon or synthetic rubber at the upper part of one side will have an array of numbers with a fixed interval for secret code entry and that the second plastic sheet, having switch connectors that will response to the number array placed on the first plastic sheet, will be placed inside the lower part of one side made of silicon and synthetic rubber.

It is desirable to place a semicircular indented guide at the lower part of the front and back side of the card to prevent accidental pressure on the above described secret code entry keys and to help increase the accuracy of the input key entries.

A power source consisting of a thin-film photovoltaic solar film can be included to supply electric power necessary for the operation of each component circuitry of the above-described card.

A display window can be added to show readiness for use within a limited time period after the entry of correct secrete number or to show error messages when wrong secret code is entered in accordance with the control of the above-described control section.

It is desirable to use the hybrid card made in combination of magnetic film strip and IC for the above-described card.

It is desirable to include a relay timer in the above-described control section to cut off the supply of magnetic power from the permanent magnetic source and switch circuitry when a fixed time is elapsed after the entry of correct secret code through the above-described secret code entry keys and the use of the card. The above-described control section can be IC chips. The method to activate the card equipped with secret code entry keys in accordance with the present invention, which is to achieve the purposes set forth above, is as follows: for a magnetic card of a hybrid card with magnetic strip and ICs, the whole or part of data patterns in the magnetic film strip are printed in non-magnetized state, and only when the correct secret code is entered through the entry keys fixed at the lower part of one side of the above-described card, the card can be read as the magnetism is supplied to the whole or part of the above-described magnetic film, thus activating the card.

Another method to activate the card equipped with secret code entry keys in accordance with the present invention is as follows: for a magnetic card or of a hybrid card with magnetic strip and ICs, the whole or part of data patterns in the magnetic film strip are printed magnetized at such a low level that a card reader or a cash dispensing machine cannot read, and only when the correct secret code is entered through the entry keys fixed at the lower part of one side of the above-described card, the card can be read as sufficient magnetism is supplied to the whole or part of the above-described magnetic film, thus activating the card.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 illustrates the plan view of the exiting related art for the card security system.

FIG. 2 illustrate a sidelong view of the card equipped with entry keys.

FIG. 3 illustrates a sidelong view of separate layers of the card.

FIG. 4a illustrates a sidelong view of the method pf inputting secret numbers using a finger tip.

FIG. 4b illustrates a sidelong view of the method of inputting secret numbers using a pencil tip.

FIG. 5 illustrates a plan view of the circuitry block inside the card.

FIG. 6a illustrates a sidelong view of the card equipped with secret number entry keys with solar power source.

FIG. 6b illustrates a plan view of the components of the card equipped with secret code entry keys.

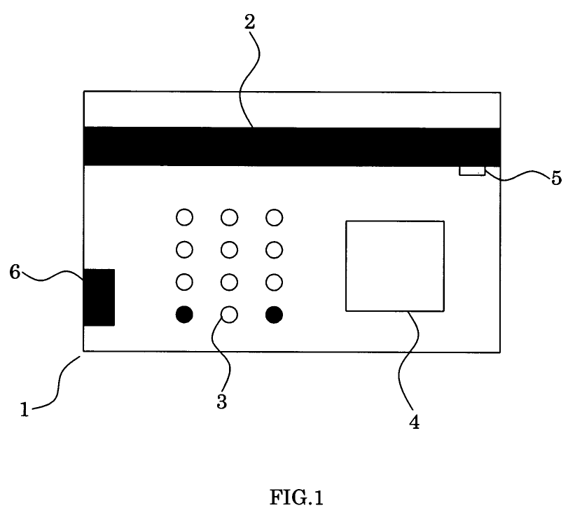

### DETAILED DESCRIPTION OF THE PREFERRED EMBODIMENT

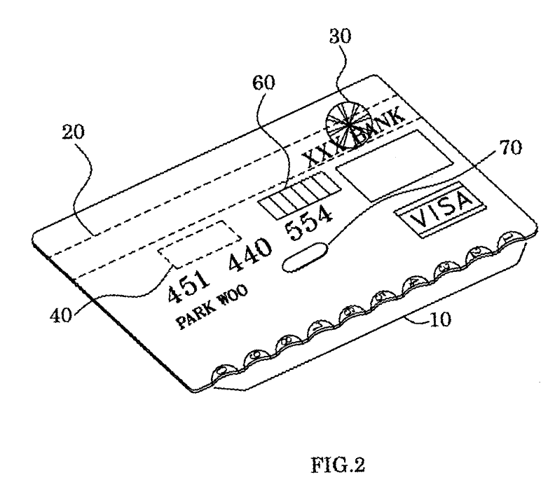

Reference will now be made in detail to the preferred embodiments of the present invention, examples of which are illustrated in the accompanying drawings. FIG. 2 illustrates a sidelong view of the card equipped with secret code entry keys. FIG. 2 represents an example of the application of the present invention. This example of the application of the present invention includes the secret number entry keys (10) formed at the lower part of one side of the card to activate or deactivate the card, the magnetic film strip (20) on which the whole or a part of the data patterns are printed unmagnetized, the control section or the IC chip (30) connected to the entry keys (10) that controls the supply of magnetic power to the magnetic film (20) in accordance with the secret number being entered, and a thin, film permanent magnetic material (40) to supply magnetic power to the magnetic strip (20). The card that embodies the present invention may include, on the front surface of the card, the power source part (60) consisting of a photovoltaic solar film to supply electricity to component circuitries inside the card. The above-described photovoltaic solar film (60) may generate electricity using light sources that are available in normal operating environment of the card (e.g. electric light and natural light). If the control part (30) is made of IC chips, electric power may be supplied using coils inside the chips.

As shown in FIG. 2, the card that applies the present invention has a display window (70) that displays readiness of the card for usage, i.e. “OK” status for a fixed period of time, e.g. 30 minutes or 60 minutes, after the correct secret number is entered through secret number entry keys (10) under the control of the control part (30). The display will show an error message when a wrong number is entered.

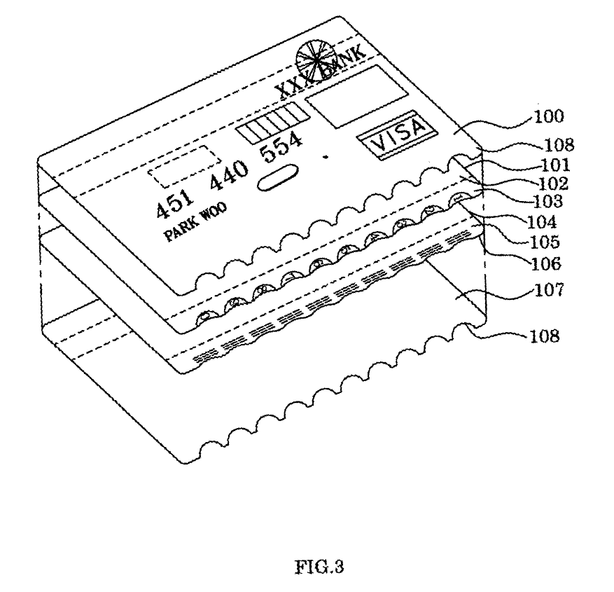

FIG. 3 illustrates a sidelong view of separate layers that compose the card. The card that applies the present invention consists of the front side (100) and the back side (107) made of plastic and layers inserted in-between. The inserted layers are made of plastic materials (101, 104) and elastic silicon or synthetic rubber at the lower part of one side (103, 105). The layers made of plastic materials consist of the first plastic layer (101) and the second plastic layer (104) that is joined together.

The above-described first plastic layer is connected to a partial layer made of plastic materials (102) at the lower part of one side made of silicon rubber or synthetic rubber, on the upper part of which there are array of numbers at fixed intervals. The second plastic layer (104) also has the lower part of one side made of silicon rubber of synthetic rubber (105) connected to the partial layer of plastic and the inside of the lower part of one side (105) are switch connectors that can be connected when the array of numbers placed on the first plastic layer are pressed. The two layers an be combined into one layer to facilitate the manufacturing process.

As shown in FIG. 3, the above-described switch connectors are not affected by pressure from the front or back sides (100, 107), but can be connected only when pressure is applied from the side.

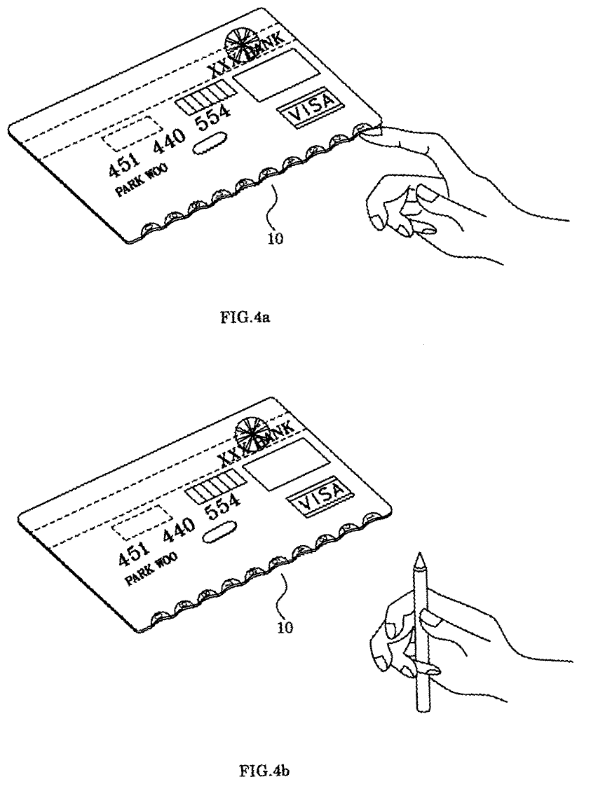

The lower part of one side (103) of the first plastic layer (101) where the row of numbers are placed for the entry of secret numbers and the lower part of one side (105) of the second plastic layer (104) where the switch connectors (106) are inserted have dimples so that secret numbers are easily entered by using the tip of fingers or writing instruments applying pressure on the secret number entry keys when the card equipped with the application of the present invention as showing in FIG. 4a or 4b. The front and back sides of the above-described card have multiple numbers of semicircular indented guides with protruding intervals (108) so that a user can be guided to the right position to enter the secret numbers correctly and accidental pressure on the entry keys can be prevented.

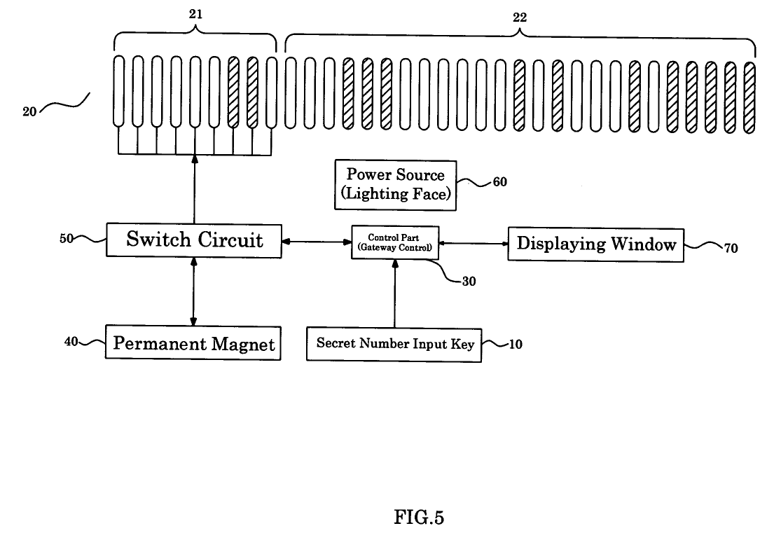

FIG. 5 illustrates a plan view of the circuitry blocks inside the card equipped with secret number entry keys, an example of the application of the present invention.

The inside circuitry of the card equipped with secret number entry keys in accordance with the present invention consists of the secret code input keys (10) to enter the secret number to activate or deactivate the card that are placed at the lower part of one side, the magnetic film strip (20) printed on the card with data signal patterns, a part of whole of which is non-magnetized, the gateway control (30) to control the flow of magnetism to the above-described magnetic film strip (20), a thin-film permanent magnet (40) to supply magnetism to the above-described magnetic film, and a switch circuitry (50) to supply magnetism to the above-described in accordance with the control of the above-described gateway control (30).

A power source consisting of a thin-film photovoltaic solar film can be included to supply electric power necessary for the operation of each component circuitry of the above-described card.

Using the installed control program, the above-described control section (30) checks the secret code entered by pressure on the secret number input entry keys against the secret number stored in the program (not shown in the figure). If the two numbers match, where the whole or (20) part of data patterns in the magnetic film strip are printed in non-magnetized state, the card can be read as the magnetism is supplied to the whole or part of the above-described magnetic film, thus activating the card.

Using the installed control program, the above-described control section (30) checks the secret code entered by pressure on the secret number input entry keys against the secret number stored in the program (not shown in the figure). If the two numbers match, where the whole or (20) part of data patterns in the magnetic film strip are printed in non-magnetized state, the card can be read as the magnetism is supplied to the whole or part of the above-described magnetic film, thus activating the card.

The above-described control part (30) of the card may include a relay timer (not shown in the figure) to cut off the supply of magnetism for the permanent magnetic materials (40) and switch circuitry (50) when a fixed time (e.g. 30 minutes or 60 minutes) elapses after the use of the card by entering the correct secret number through the secret number input keys (10).

As shown in FIG. 2, the card that applies the present invention has a display window (70) that displays readiness of the card for usage, i.e. “OK” status for a fixed period of time, e.g. 30 minutes or 60 minutes, after the correct secret number is entered through secret number entry keys (10) under the control of the control part (30). The display will show an error message when a wrong number is entered.

The control part (30) of the card that applies the present invention may include a function control program to ensure the accuracy of the first secret number entry by requiring a user to enter the four-digit secret number four times before the secret number is established.

The control part (30) of the card equipped with secret number entry keys in accordance with the present invention may include a simple card operating system (COS) program. When a correct card user uses the card for the first time by entering the secret number, the COS program enables transmission of the secret number at the same time with the approval request from the card reader and automatic registration of the secret number at the card approval system. Accordingly, when the above-described card is stolen, lost, copied, or forged and an unauthorized user tries to use the card without entering the secret number or by entering a wrong secret number, the card will be deactivated and the transaction will not be approved. Furthermore, the card company or the security company will alert so that unauthorized use of stolen, lost, forged or copied card will be prevented.

The card equipped with secret number entry keys in accordance with the present invention can be used not only as credit cards or cash cards but also as security cards for high-level security clearance, entry cards or electronic identification cards.

As stated above, the method to activate the card quipped with secret number entry keys in accordance with the present invention is as follows: for a magnetic card of a hybrid card with magnetic strip and ICs, the whole or part of data patterns in the magnetic film strip are printed in non-magnetized state, and only when the correct secret code is entered through the entry keys fixed at the lower part of one side of the above-described card, the card can be read as the magnetic power is supplied to the whole or part of the above-described magnetic film, thus activating the card.

The magnetic film strip in the magnetic card is designed to record data signals including the user's identity data (in binary form) on the magnetic strip like a bar code using magnetic materials like oxidized iron, that can be read by card readers and cash dispensing machines. In the present invention, however, when the data is recorded in signal patterns when the card is issued, the whole (20) or part (21) of data patterns in the magnetic film strip are printed unmagnetized, and only when the correct secret code is entered through the entry keys fixed at the lower part of one side of the above-described card, the card can be read as magnetism is supplied from the permanent magnet (40).

Another method to activate the card equipped with secret code entry keys in accordance with the present invention is as follows: for a magnetic card of a hybrid card with magnetic strip and ICs, the whole or part of data patterns in the magnetic film strip are printed magnetized at such a low level that a card reader or a cash dispensing machine cannot read, and only when the correct secret code is entered through the entry keys fixed at the lower part of one side of the above-described card, the card can be read as sufficient magnetism is supplied to the whole or part of the above-described magnetic film, thus activating the card.

As stated in the preceding paragraphs, the card that applies the present invention can prevent loss of card users, accepting establishments and the card companies from unauthorized use when the card is lost or stolen and prevent the use of forged or copied cards. Further, the adoption and use of the above-described cards will not entail additional expenses because the existing card readers and network systems can be used as they are.

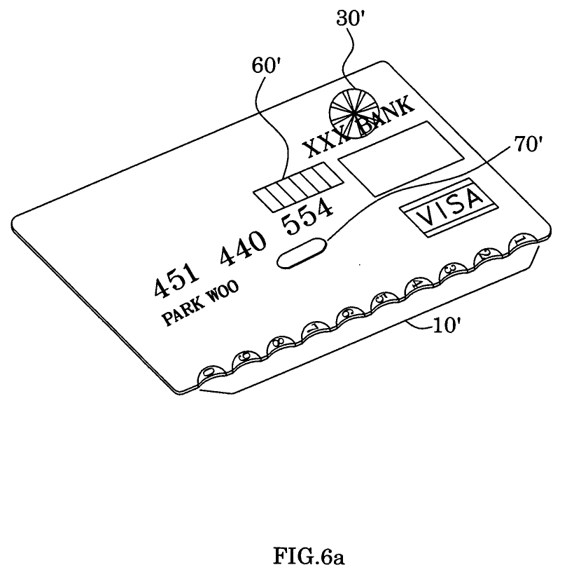

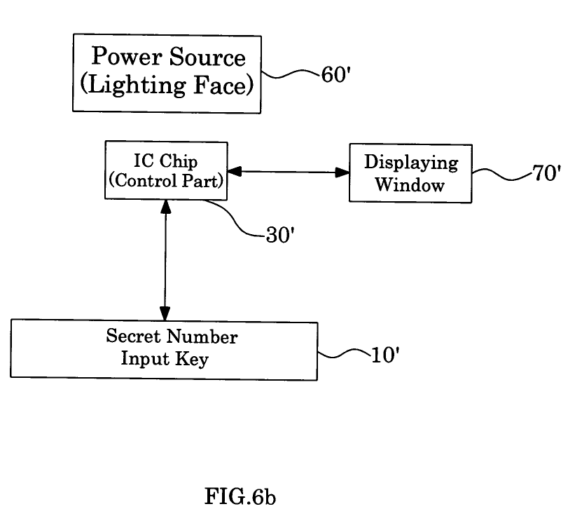

As stated in the preceding paragraphs, the card equipped with secret number entry keys and the method to activate the same can be applied in various different ways. FIGS. 6a and 6b illustrate the application of the present invention to an IE control card (also known as a smart card), showing a sidelong view and a block diagram, respectively.

The card equipped with secret number entry keys, an example of the application of the present invention, includes the secret number entry keys (10′) formed at the lower part of one side of the card to activate the card, the IC chip (30′) connected electrically to the entry keys (10′) that controls the output of data including card and user information in accordance with secret numbers, and display window that displays readiness of the card for usage after the correct secret number is entered through secret number entry keys (10′) under the control of the control part (30′). The display will show an error message when a wrong number is entered

The above-described IC chips of the card may include a relay timer (not shown in the figure) to cut off the data output when a fixed time elapses after the use of the card. The card equipped with the secret number input keys, an example of the application of the present invention, may get electricity from the coils installed inside the IC chips (30′) or from a separate power sources consisting of photovoltaic solar film (60′).

The structure and composition of the above-described entry keys (10) are same as those of the secret number entry keys (10) as explained in FIG. 3. Also, the above-described IC chips (30) with the installed control programs can be set to have the same functions as the control part (30) referred to in FIGS. 2 and 5.

As was discussed in the preceding paragraphs, the present invention is directed to a device to input a user-defined secret code to activate the card with magnetic film strip, integrated circuitry or the combination of the two and a method of activating the card. The key entry device is fixed at a side of the card. The card equipped with the device and the method of the present invention operates only when the defined secret code is entered and, therefore, can prevent unauthorized use of the card when it is stolen or lost. Also the present invention will prevent the use of copied or forged cards.

As stated in the preceding paragraphs, the card that applies the present invention can prevent loss of card users, accepting establishments and the card companies from unauthorized use when the card is lost or stolen and prevent the use of forged or copied cards. Further, the adoption and use of the above-described cards will not entail additional expenses because the existing card readers and network systems can be used as they are.

Although the above explanation was limited to the examples of the application of the present invention referred to above, it is clear that there can be various modification and variation within the technical specifications of the present invention. Accordingly, it is only natural to include any variations and modifications in the present patent claims.

What is claimed is:

1. As stated in the preceding paragraphs, the card equipped with secret number entry keys and the method to activate the same can be applied in various different ways. FIGS. 6a and 6b illustrate the application of the present invention to an IE control card (also known as a smart card), showing a sidelong view and a block diagram, respectively.

2. Using the installed control program, the above-described control section (30) checks the secret code entered by pressure on the secret number input entry keys against the secret number stored in the program (not shown in the figure). If the two numbers match, where the whole or (20) part of data patterns in the magnetic film strip are printed in non-magnetized state, the card can be read as the magnetism is supplied to the whole or part of the above-described magnetic film, thus activating the card.

3. FIG. 2 illustrate a sidelong view of the card equipped with entry keys.

4. FIG. 3 illustrates a sidelong view of separate layers of the card.

5. FIG. 4a illustrates a sidelong view of the method pf inputting secret numbers using a finger tip.

6. FIG. 4b illustrates a sidelong view of the method of inputting secret numbers using a pencil tip.

7. FIG. 5 illustrates a plan view of the circuitry block inside the card.

8. FIG. 6a illustrates a sidelong view of the card equipped with secret number entry keys with solar power source.

9. FIG. 6b illustrates a plan view of the components of the card equipped with secret code entry keys.

10. FIG. 6a illustrates a sidelong view of the card equipped with secret number entry keys with solar power source.

11. FIG. 2 illustrates a sidelong view of the card equipped with secret code entry keys. FIG. 2 represents an example of the application of the present invention. This example of the application of the present invention includes the secret number entry keys (10) formed at the lower part of one side of the card to activate or deactivate the card, the magnetic film strip (20) on which the whole or a part of the data patterns are printed unmagnetized, the control section or the IC chip (30) connected to the entry keys (10) that controls the supply of magnetic power to the magnetic film (20) in accordance with the secret number being entered, and a thin, film permanent magnetic material (40) to supply magnetic power to the magnetic strip (20). The card that embodies the present invention may include, on the front surface of the card, the power source part (60) consisting of a photovoltaic solar film to supply electricity to component circuitries inside the card. The above-described photovoltaic solar film (60) may generate electricity using light sources that are available in normal operating environment of the card (e.g. electric light and natural light). If the control part (30) is made of IC chips, electric power may be supplied using coils inside the chips.

12. As shown in FIG. 2, the card that applies the present invention has a display window (70) that displays readiness of the card for usage, i.e. “OK” status for a fixed period of time, e.g. 30 minutes or 60 minutes, after the correct secret number is entered through secret number entry keys (10) under the control of the control part (30). The display will show an error message when a wrong number is entered.
